(19) United States
(12) Patent Application Publication
(10) Pub. No.: US 2026/0367267 A1
(43) Pub. Date: Nov. 19, 2026

(54) METHOD FOR CONSTRUCTING A NON-UNIFORM WAVE VELOCITY FIELD MODEL FOR AN UNDERGROUND MINE

(71) Applicant: NORTHEASTERN UNIVERSITY, SHANGYANG (CN)

(72) Inventors: PENGHAI ZHANG, SHENYANG (CN); TIANHONG YANG, SHENYANG (CN); YONG ZHAO, SHENYANG (CN); YUXIN BAI, SHENYANG (CN); QINGSHAN MA, SHENYANG (CN); XIAOYAN XIE, SHENYANG (CN); JIAN ZHONG, SHENYANG (CN); JIAHAO ZHANG, SHENYANG (CN)

(73) Assignee: NORTHEASTERN UNIVERSITY, SHENYANG (CN)

(21) Appl. No.: 19/362,815

(22) Filed: Oct. 20, 2025

(30) Foreign Application Priority Data
May 13, 2025 (CN) 202510608624.X

(51) Int. Cl. G01V 1/28; G01V 1/30

(52) U.S. Cl. CPC G01V 1/282; G01V 1/303; G01V 1/306

(57) ABSTRACT

A method for constructing a non-uniform wave velocity field model for an underground mine is disclosed. The method comprises: preparing rock specimens from various materials and performing wave velocity tests to create a wave velocity quantification formula by fitting experimental data. A three-dimensional (3D) block model of a prediction area is constructed, divided into block unit models, and interpolated to generate lithological block unit models. A 3D engineering geological characterization model is then constructed, and its geological feature data is extracted. The wave velocity quantification formula is used to assign a wave velocity to each lithological block unit model, thereby obtaining the final 3D non-uniform wave velocity field model. The invention provides a velocity field model that more accurately reflects the actual conditions of an underground mine, overcoming the limitations of constant velocity assumptions in traditional models and enhancing the reliability of microseismic monitoring.

### TECHNICAL FIELD

The present invention pertains to the technical field of mine safety monitoring and rock mass engineering detection, and more specifically, discloses a method for constructing a non-uniform wave velocity field model for an underground mine.

### BACKGROUND

China is rich in mineral resources, with statistics indicating that the total number of underground mines has surpassed 10,000, the majority of which are small to medium-sized. Following the implementation of the “Safety Regulations for Metal and Non-metal Underground Mines,” the application of microseismic monitoring technology that conforms to the “Six Major Systems” for safety and hazard avoidance has become a mandatory requirement for mine production safety. The precision of microseismic monitoring technology, which is based on the propagation velocity of elastic waves through a medium, is largely dependent on the three-dimensional spatial distribution of the wave velocity field. However, in underground mines, the rock mass, which serves as the propagation medium, is characterized by discontinuities and heterogeneity. It is subjected to in-situ stresses that vary with depth and is also affected by man-made engineering structures such as tunnels and goafs (mined-out areas). These factors result in a complex, non-uniform wave velocity field, which significantly impacts the propagation paths and arrival time calculations of microseismic signals.

Traditional uniform wave velocity models or partitioned-uniform models based on lithology fail to comprehensively consider the effects of rock mass structural features, in-situ stresses, and underground mine voids. This leads to wave velocity inversion errors exceeding ±15%, making it difficult to meet the requirement of a disaster warning response time of ≤30 seconds as stipulated by the “Safety Regulations for Metal and Non-metal Underground Mines.” Therefore, based on the quantification of the influence of key geological parameters on wave velocity, and by integrating data on rock mass fracture characteristics, in-situ stress patterns, and the distribution of underground mine voids, the present invention proposes a method for constructing a non-uniform wave velocity field model applicable to underground mines. This method effectively overcomes the limitations of the constant velocity assumption in traditional models and enhances the reliability of microseismic monitoring.

### SUMMARY

To address the problems in existing models, such as the assumption of constant wave velocity and the failure to comprehensively consider the effects of rock mass structural features, in-situ stresses, and underground mine voids, which lead to excessive wave velocity inversion errors, the present invention provides a method for constructing a non-uniform wave velocity field model for an underground mine.

The present invention provides a method for constructing a non-uniform wave velocity field model for an underground mine, comprising the following steps:
S1. Selecting a plurality of rock materials, preparing a plurality of regular blocks therefrom, and measuring a reference wave velocity for each of the regular blocks;
S2. Utilizing the regular blocks to prepare rock specimens, performing wave velocity tests on each of the rock specimens to obtain experimental data, and constructing a wave velocity quantification formula by fitting the experimental data;
S3. Constructing a three-dimensional (3D) block model of a prediction area based on spatial features of the prediction area, selecting a unit size, dividing the 3D block model into a plurality of block unit models according to the unit size, and generating lithological block unit models by performing spatial interpolation on the block unit models;
S4. Constructing a 3D engineering geological characterization model based on a mapping relationship between Rock Quality Designation (RQD) values and fracture density, lithological data of the prediction area, in-situ stress test data of the prediction area, the spatial features of the prediction area, and the 3D block model; and
S5. Extracting geological feature data from the 3D engineering geological characterization model, assigning a wave velocity to each of the plurality of lithological block unit models using the wave velocity quantification formula based on the geological feature data, and iterating through all the lithological block unit models to obtain a 3D non-uniform wave velocity field model.

The step S2 further comprises the following steps:
S201. Pre-fabricating different fracture densities and different fracture dip angles in the plurality of regular blocks using a Brazilian splitting method to obtain the plurality of rock specimens;
S202. Placing the rock specimens in a fixture, performing wave velocity tests on each of the rock specimens under different normal stress conditions, and recording the experimental data, wherein the experimental data includes wave velocity, the fracture density of the rock specimen, the normal stress applied to the rock specimen, and the fracture dip angle of the rock specimen, and wherein the fracture dip angle is an angle between a fracture and the normal stress; and
S203. Plotting experimental data curves based on the experimental data, establishing a fitting formula, and thereby constructing the wave velocity quantification formula, wherein the wave velocity quantification formula is as shown in formula (1):

$$v = \sqrt{A \cdot {sin}^{2} α + B {cos}^{2} α} \cdot {v}_{0} \cdot {log}_{2} ( C \cdot p - D \cdot m + E ) \qquad ( 1 )$$

where v represents the wave velocity, v₀ represents the reference wave velocity, m represents the fracture density of the rock specimen, p represents the normal stress applied to the rock specimen, a represents the fracture dip angle of the rock specimen, A represents a sine weight coefficient for the fracture dip angle, B represents a cosine weight coefficient for the fracture dip angle, C represents a normal stress gain coefficient, D represents a fracture density attenuation coefficient, and E represents a comprehensive correction coefficient, wherein the sine weight coefficient, the cosine weight coefficient, the normal stress gain coefficient, the fracture density attenuation coefficient, and the comprehensive correction coefficient are constant coefficients obtained by fitting the experimental data.

According to some embodiments of the present application, the step S3 further comprises the following steps:
S301. Constructing the 3D block model based on the spatial features of the prediction area;
S302. Selecting the unit size, and dividing the 3D block model into the plurality of identically sized block unit models based on the spatial features of the prediction area and the unit size; and
S303. Performing spatial interpolation for each of the block unit models based on the lithological data of the prediction area to generate the plurality of lithological block unit models.

According to some embodiments of the present application, the spatial features of the prediction area in step S3 include: geometric parameters of the prediction area, a 3D layout of voids within the prediction area, geometric parameters of the voids within the prediction area, a number of boreholes within the prediction area, a volume of the boreholes within the prediction area, and a shape of the boreholes within the prediction area;
wherein the voids within the prediction area include tunnels and goafs within the prediction area.

According to some embodiments of the present application, the step S4 further comprises the following steps:
S401. Extracting the 3D layout and geometric parameters of tunnels within the prediction area based on engineering structural diagrams of the prediction area, simulating the tunnels as pipes, and constructing an interconnected tunnel model;
S402. Extracting the 3D layout and geometric parameters of goafs within the prediction area based on the engineering structural diagrams, simulating the goafs as cuboids of different sizes, and constructing a goaf model;
S403. Merging the tunnel model and the goaf model using a Boolean union operation to obtain a void model of the prediction area, thereby obtaining void information for the prediction area;
S404. Constructing an in-situ stress calculation formula through outlier screening and multiple linear regression analysis based on the in-situ stress test data of the prediction area, thereby obtaining the in-situ stress of the prediction area;
S405. Collecting a plurality of rock cores from the prediction area, capturing images of the rock cores, and obtaining RQD values for the rock cores;
S406. Inputting the RQD values into a preset mapping relationship between RQD values and fracture density to obtain the fracture density; and
S407. Performing spatial interpolation on the lithological block unit models based on the void information, the in-situ stress, the fracture density, and the lithological data of the prediction area to construct the 3D engineering geological characterization model.

According to some embodiments of the present application, the step S405 further comprises the following steps:
S415. Collecting a plurality of rock cores from the prediction area and capturing a plurality of rock core images of the prediction area;
S425. Identifying marking information in each of the rock core images using Optical Character Recognition (OCR) technology to generate a file containing a borehole number and a borehole depth, and uniformly naming the file;
S435. Parsing a core length of a borehole corresponding to the rock core image based on the naming of the file;
S445. Automatically cropping an effective area of the rock core using an object detection algorithm, identifying a lithology name of the effective area, and assigning a corresponding lithology code; and
S455. Identifying a length of the effective area using a semantic segmentation model and calculating the RQD value of the rock core.

According to some embodiments of the present application, the lithological data of the prediction area includes: the borehole number, the borehole depth, the core length of the borehole, the lithology name, the lithology code, the length of the effective area, and the RQD value.

According to some embodiments of the present application, the preset mapping relationship between RQD values and fracture density in step S406 is as shown in formula (2):

$$RQD ( n ) = \{ \begin{matrix}\frac{n}{n + 1} {\int }_{0.1}^{1} f ( x ) xdx + \frac{1}{n + 1} , 0 \leq n \leq 9 \\ \frac{n}{n + 1} {\int }_{0.1}^{1} f ( x ) xdx , n > 9\end{matrix} \qquad ( 2 )$$

where n represents the fracture density, f(x) represents a fracture distribution function, and x represents fracture spacing;
wherein the fracture spacing is obtained by fitting the experimental data curves.

According to some embodiments of the present application, the step S5 further comprises the following steps:
S501. Presetting a lithological data-to-reference wave velocity mapping relationship based on the plurality of rock materials and the measured reference wave velocities;
S502. Assigning a reference wave velocity to each of the lithological block unit models according to the preset lithological data-to-reference wave velocity mapping relationship, and iterating through all the lithological block unit models to obtain a 3D block reference wave velocity model;
S503. Reading the in-situ stress, the fracture density, the fracture dip angle, and the void information from the 3D engineering geological characterization model;
S504. Calculating the normal stress based on the in-situ stress of the prediction area;
S505. Constructing a wave velocity quantification formula for the non-uniform wave velocity field based on the wave velocity quantification formula, as shown in formula (3):

$$V = \sqrt{A \cdot {sin}^{2} β + B {cos}^{2} β} \cdot {v}_{0} \cdot {log}_{2} ( C \cdot P - D \cdot n + E ) \qquad ( 3 )$$

where V represents the wave velocity of the non-uniform wave velocity field, v₀ represents the reference wave velocity, n represents the fracture density, P represents the normal stress, β represents the fracture dip angle, A represents the sine weight coefficient for the fracture dip angle, B represents the cosine weight coefficient for the fracture dip angle, C represents the normal stress gain coefficient, D represents the fracture density attenuation coefficient, and E represents the comprehensive correction coefficient, wherein the coefficients are constant coefficients obtained by fitting the experimental data; and
S506. Substituting the fracture density, the fracture dip angle, and the normal stress into the wave velocity quantification formula for the non-uniform wave velocity field to update the wave velocities in the 3D block reference wave velocity model, thereby obtaining the 3D non-uniform wave velocity field model; wherein, in conjunction with the void information of the prediction area, the wave velocity in the voids is directly updated to an atmospheric wave velocity.

The method for constructing a non-uniform wave velocity field model for an underground mine proposed by the present invention can quantify the corresponding wave velocity for different regions by comprehensively considering the effects of rock mass structural features, in-situ stresses, and underground mine voids. Combined with geostatistical interpolation, it generates a 3D non-uniform wave velocity field characterization model that more accurately reflects the actual conditions of an underground mine. This effectively addresses the significant wave velocity inversion errors caused by traditional uniform wave velocity models or partitioned-uniform models based on lithology, thereby laying a foundation for high-precision microseismic source location.

### BRIEF DESCRIPTION OF THE DRAWINGS

FIG. 1 is a schematic flowchart of a method for constructing a non-uniform wave velocity field model for an underground mine according to Embodiment 1 of the present invention.

### DETAILED DESCRIPTION

The embodiments of the present invention will be further described in detail below with reference to the accompanying drawings and examples. The following examples are intended to illustrate the invention and not to limit its scope.

### Embodiment 1

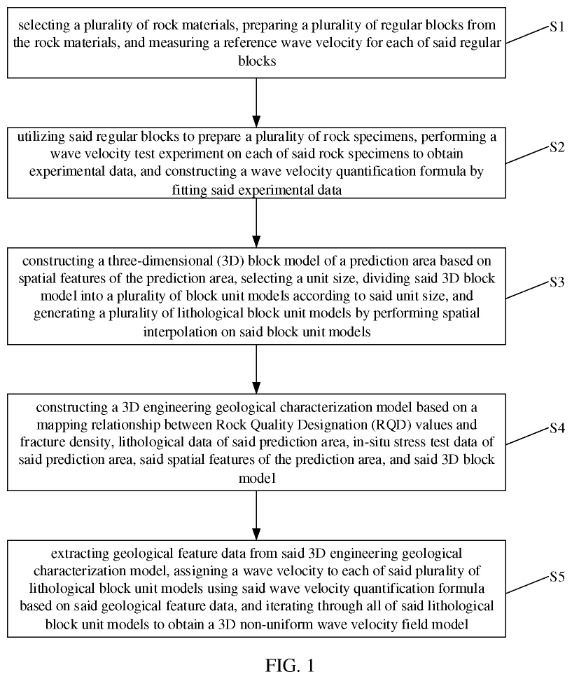

This embodiment provides a method for constructing a non-uniform wave velocity field model for an underground mine, as shown in FIG. 1, which includes the following steps:
S1. Selecting a plurality of rock materials, preparing a plurality of regular blocks therefrom, and measuring a reference wave velocity for each of the regular blocks.
S2. Utilizing the regular blocks to prepare rock specimens, performing wave velocity tests on each of the rock specimens to obtain experimental data, and constructing a wave velocity quantification formula by fitting the experimental data.
S3. Constructing a three-dimensional (3D) block model of a prediction area based on spatial features of the prediction area, selecting a unit size, dividing the 3D block model into a plurality of block unit models according to the unit size, and generating lithological block unit models by performing spatial interpolation on the block unit models.
S4. Constructing a 3D engineering geological characterization model based on a mapping relationship between Rock Quality Designation (RQD) values and fracture density, lithological data of the prediction area, in-situ stress test data of the prediction area, the spatial features of the prediction area, and the 3D block model.
S5. Extracting geological feature data from the 3D engineering geological characterization model, assigning a wave velocity to each of the plurality of lithological block unit models using the wave velocity quantification formula based on the geological feature data, and iterating through all the lithological block unit models to obtain a 3D non-uniform wave velocity field model.

### Embodiment 2

This embodiment provides a method for constructing a non-uniform wave velocity field model for an underground mine, which includes the following steps:
S1. Selecting a plurality of rock materials, preparing a plurality of regular blocks therefrom, and measuring a reference wave velocity for each of the regular blocks.
S201. Pre-fabricating different fracture densities and different fracture dip angles in the plurality of regular blocks using a Brazilian splitting method to obtain a plurality of rock specimens.
S202. Placing the rock specimens in a fixture, performing wave velocity tests on each of the rock specimens under different normal stress conditions, and recording the experimental data, wherein the experimental data includes wave velocity, the fracture density of the rock specimen, the normal stress applied to the rock specimen, and the fracture dip angle of the rock specimen, and wherein the fracture dip angle is an angle between a fracture and the normal stress.
S203. Plotting experimental data curves based on the experimental data, establishing a fitting formula, and thereby constructing the wave velocity quantification formula, wherein the wave velocity quantification formula is as shown in formula (1):

$$v = \sqrt{A \cdot {sin}^{2} α + B {cos}^{2} α} \cdot {v}_{0} \cdot {log}_{2} ( C \cdot p - D \cdot m + E ) \qquad ( 1 )$$

where v represents the wave velocity, v₀ represents the reference wave velocity, m represents the fracture density of the rock specimen, p represents the normal stress applied to the rock specimen, a represents the fracture dip angle of the rock specimen, A represents a sine weight coefficient for the fracture dip angle, B represents a cosine weight coefficient for the fracture dip angle, C represents a normal stress gain coefficient, D represents a fracture density attenuation coefficient, and E represents a comprehensive correction coefficient, wherein the coefficients are constant coefficients obtained by fitting the experimental data. Preferably, in this embodiment, the sine weight coefficient for the fracture dip angle is used to control the contribution weight of the sine term of the fracture dip angle to the wave velocity; the normal stress gain coefficient is used to adjust the amplification ratio of the normal stress in a logarithmic function, reflecting the positive enhancement effect of normal stress on the wave velocity; the fracture density attenuation coefficient is used to control the weakening effect of fracture density on the wave velocity, where a larger value indicates a more significant negative impact of fracture density on the wave velocity; and the comprehensive correction coefficient is used to correct errors in data fitting.
S301. Constructing the 3D block model based on the spatial features of the prediction area.
S302. Selecting the unit size, and dividing the 3D block model into a plurality of identically sized block unit models based on the spatial features of the prediction area and the unit size. Preferably, in this embodiment, the spatial features of the prediction area include: geometric parameters of the prediction area, a 3D layout of voids within the prediction area, geometric parameters of the voids within the prediction area, a number of boreholes within the prediction area, a volume of the boreholes within the prediction area, and a shape of the boreholes within the prediction area. The voids within the prediction area include tunnels and goafs.
S303. Performing spatial interpolation for each of the block unit models based on the lithological data of the prediction area to generate a plurality of lithological block unit models.
S401. Extracting the 3D layout and geometric parameters of tunnels within the prediction area based on engineering structural diagrams of the prediction area, simulating the tunnels as pipes, and constructing an interconnected tunnel model.
S402. Extracting the 3D layout and geometric parameters of goafs within the prediction area based on the engineering structural diagrams, simulating the goafs as cuboids of different sizes, and constructing a goaf model.
S403. Merging the tunnel model and the goaf model using a Boolean union operation to obtain a void model of the prediction area, thereby obtaining void information for the prediction area.
S404. Constructing an in-situ stress calculation formula through outlier screening and multiple linear regression analysis based on the in-situ stress test data of the prediction area, thereby obtaining the in-situ stress of the prediction area.
S405. Collecting a plurality of rock cores from the prediction area, capturing images of the rock cores, and obtaining RQD values for the rock cores. Preferably, in this embodiment, step S405 includes steps S415 to S455, as detailed below.
S415. Collecting a plurality of rock cores from the prediction area, marking corresponding borehole information, and capturing a plurality of rock core images of the prediction area. Preferably, in this embodiment, the borehole information includes a borehole number, a borehole depth, and a core length of the borehole.
S425. Identifying marking information in each of the rock core images using Optical Character Recognition (OCR) technology to generate a file containing the borehole number and the borehole depth, and uniformly naming the file.
S435. Parsing the core length of a borehole corresponding to the rock core image based on the naming of the file.
S445. Automatically cropping an effective area of the rock core using an object detection algorithm, identifying a lithology name of the effective area, and assigning a corresponding lithology code.
S455. Identifying a length of the effective area using a semantic segmentation model and calculating the RQD value of the rock core. S406. Inputting the RQD values into a preset mapping relationship between RQD values and fracture density to obtain the fracture density. Preferably, in this embodiment, the preset mapping relationship between RQD values and fracture density is as shown in formula (2):

$$RQD ( n ) = \{ \begin{matrix}\frac{n}{n + 1} {\int }_{0.1}^{1} f ( x ) xdx + \frac{1}{n + 1} , 0 \leq n \leq 9 \\ \frac{n}{n + 1} {\int }_{0.1}^{1} f ( x ) xdx , n > 9\end{matrix} \qquad ( 2 )$$

where n represents the fracture density, f(x) represents a fracture distribution function, and x represents fracture spacing. Preferably, the fracture spacing is obtained by fitting experimental data curves.
S407. Performing spatial interpolation on the lithological block unit models based on the void information, the in-situ stress, the fracture density, and the lithological data of the prediction area to construct the 3D engineering geological characterization model. Preferably, in this embodiment, the lithological data of the prediction area includes: the borehole number, the borehole depth, the core length of the borehole, the lithology name, the lithology code, the length of the effective area, and the RQD value.
S501. Presetting a lithological data-to-reference wave velocity mapping relationship based on the plurality of rock materials and the measured reference wave velocities.
S502. Assigning a reference wave velocity to each of the lithological block unit models according to the preset lithological data-to-reference wave velocity mapping relationship, and iterating through all the lithological block unit models to obtain a 3D block reference wave velocity model.
S503. Reading the in-situ stress, the fracture density, the fracture dip angle, and the void information from the 3D engineering geological characterization model.
S504. Calculating the normal stress based on the in-situ stress of the prediction area.
S505. Constructing a wave velocity quantification formula for the non-uniform wave velocity field based on the wave velocity quantification formula, as shown in formula (3):

$$V = \sqrt{A \cdot {sin}^{2} β + B {cos}^{2} β} \cdot {v}_{0} \cdot {log}_{2} ( C \cdot P - D \cdot n + E ) \qquad ( 3 )$$

where V represents the wave velocity of the non-uniform wave velocity field, v0 represents the reference wave velocity, n represents the fracture density, P represents the normal stress, β represents the fracture dip angle, and A,B,C,D,E are the previously defined constant coefficients obtained by fitting the experimental data.
S506. Substituting the fracture density, the fracture dip angle, and the normal stress into the wave velocity quantification formula for the non-uniform wave velocity field to update the wave velocities in the 3D block reference wave velocity model, thereby obtaining the 3D non-uniform wave velocity field model; wherein, in conjunction with the void information of the prediction area, the wave velocity in the voids is directly updated to an atmospheric wave velocity.

Embodiment 3 This embodiment provides a method for constructing a non-uniform wave velocity field model for an underground mine, which includes the following steps:
Step 1. Granite rock samples are collected from a mine site and prepared into regular blocks of 10 cm×5 cm×5 cm. The reference wave velocity of each regular block is measured.
Step 2. A through-going fracture for testing is created in each regular block by Brazilian splitting. The fracture density, determined based on the rock length, is controlled to be between 10 and 30 fractures/m, and the fracture angle is controlled to be between 50° and 90°, resulting in a plurality of rock specimens. The rock specimens with different fracture densities and fracture angles are placed and fixed in a fixture. A normal stress of 1-30 MPa is applied to both ends, and wave velocity tests are conducted simultaneously at both ends of the rock specimens, and the experimental data is recorded.
Step 3. The experimental data is fitted to establish a wave velocity quantification formula that considers fracture density, fracture angle, and normal stress, as shown in formula (4):

$$v = \sqrt{1.18 \times {10}^{- 2} \cdot {sin}^{2} α + 1.04 \times {10}^{- 2} \cdot {cos}^{2} α} \cdot {}_{0} \cdot {log}_{2} ( 123 - 1.75 + 542 ) \qquad ( 4 )$$

where v is the wave velocity, v0 is the reference wave velocity, m is the fracture density of the rock specimen, p is the normal stress applied to the rock specimen, and a is the fracture dip angle of the rock specimen, i.e., the angle between the fracture and the normal stress.
Step 4. Based on data from 596 boreholes in the mine, a lithology database is compiled, including lithology name, lithology code, start and end depths, and percentage. Lithologies with similar mineral compositions and mechanical properties are classified and merged, as shown in Table 1. Preferably, in this embodiment, the start and end depths refer to the length of the effective area of the rock core.

TABLE 1
Lithology Database of this Embodiment

| Lithology | Code | Length(m) | Percentage(%) |
|---|---|---|---|
| Gneiss | Abhg | 88523.09 | 57.343 |
| Quartz Porphyry | λπα | 30346.53 | 19.657 |
| Breccia | SKB | 19089.93 | 12.366 |
| Amphibolite | APa | 11662.96 | 7.555 |
| Quaternary | Q | 1000.11 | 0.647 |
| Rhyolite Porphyry | λπα/5 | 605.66 | 0.392 |
| Sulfide | q | 593.56 | 0.384 |
| Porphyry | ξχ | 587.09 | 0.380 |
| Alluvium | Q4apl | 365.15 | 0.236 |
| Gabbro | βμ | 317.41 | 0.205 |
| Altered Rock | sby | 306.48 | 0.198 |
| Diorite | δ | 285.72 | 0.185 |
| Cataclasite | tr | 260.46 | 0.168 |
| Fracture Zone | Sb | 218.08 | 0.141 |
| Quartz Vein | q1-2 | 97.42 | 0.063 |
| Diabase | β5μ | 90.07 | 0.058 |
| Syenite Porphyry | ξπ | 22.31 | 0.014 |
| Basalt | β6 | 0.80 | 0.101 |

Step 5. Based on the spatial features of the mine's prediction area, a 3D block model with dimensions of 2490 m (length)×2490 m (width)×1010 m (height) is established. A unit size of 10 m is selected to divide the model into 25,149 block unit models. The 15,271 block unit models containing borehole data are directly assigned lithology codes (Abhg, λπa, etc.) to become lithological block unit models. The remaining units are inferred using Ordinary Kriging interpolation to obtain all lithological block unit models for the mine.
Step 6. At the mine site, 21,614 rock core images are recorded. An RQD recognition program is used to perform object detection on the rock core images, automatically cropping the core area and removing noise. Further, a semantic segmentation method is employed to identify the effective area of the rock cores.
Step 7. Based on the RQD-to-fracture density mapping relationship, the fracture spacing is determined by fitting a probability density curve using a Gaussian distribution. The RQD is converted to fracture density using a bisection method.
Step 8. Spatial layout data of tunnels and goafs are extracted from the mine's engineering structural diagrams using 3D modeling software. The tunnels are simulated as pipes with a radius of 3 m to construct an interconnected tunnel model. The goafs are simulated as cuboids of different sizes to construct a goaf model. A Boolean union operation is performed on the tunnel model and the goaf model based on their 3D coordinates to generate a complete void model of the mine.
Step 9. The in-situ stress test data measured at the mine site is fitted. Through outlier screening and multiple linear regression analysis, a normal stress formula is constructed, as shown in formula (5):

P=0.0283H−2.0364 (5)

where H is the depth, and P is the normal stress.
Step 10. Using the previously established and divided 3D block model, the left and right lithological block unit models are assigned values for fracture density, normal stress, lithological data, and void information. Ordinary Kriging interpolation is performed to construct a 3D engineering geological characterization model that considers in-situ stress, lithology, fracture characteristics, and void distribution.
Step 11. A lithology-to-reference wave velocity table is set up. Part of the preset content in this embodiment is shown in Table 2. The lithology codes of all units in the lithological block model are converted to their corresponding reference wave velocity values.

TABLE 2
Preset Lithology-to-Reference Wave
Velocity Table of this Embodiment

| | Lithology | Reference Wave |
|---|---|---|
| Lithology | Code | Velocity (m/s) |
| Breccia | SKB | 3832 |
| Diorite | δ | 3424 |
| Quartz Vein | q1-2 | 4234 |
| Porphyry | ξχ | 3923 |
| Amphibolite | APa | 3707 |

Step 12. Geological feature data is extracted from the 3D engineering geological characterization model. The fracture density and in-situ stress parameter values of all lithological block unit models are iterated. A global average fracture angle of 45° is used. The corrected wave velocity is calculated according to the preset wave velocity quantification formula (4). The corrected wave velocities for some locations in this embodiment are shown in Table 3.

TABLE 3
Corrected Wave Velocities at Partial Locations of this Embodiment

| | Reference | Fracture | In-situ | | Corrected |
|---|---|---|---|---|---|
| 3D | Wave | Density | Stress | Fracture | Wave |
| Coordinates | Velocity | (count/m) | (MPa) | Angle | Velocity |
| 64125, 60135, | 3832 | 5.697 | 20.447 | 45 | 4407 |
| 610 | | | | | |
| 64285, 58405, | 3424 | 7.204 | 18.737 | 45 | 3808 |
| 660 | | | | | |
| 64175, 60255, | 4234 | 7.418 | 16.384 | 45 | 4056 |
| 728 | | | | | |
| 4135, 59085, | 3923 | 8.005 | 14.633 | 45 | 3758 |
| 780 | | | | | |

Step 13. The void distribution information is read from the 3D engineering geological characterization model. The wave velocities in the voids are overwritten with the general atmospheric wave velocity of 340 m/s, completing the construction of the 3D non-uniform wave velocity field for the mine.

The embodiments of the present invention are provided for the purposes of illustration and description, and are not intended to be exhaustive or to limit the invention to the precise forms disclosed. Many modifications and variations will be apparent to those of ordinary skill in the art. The embodiments were chosen and described in order to best explain the principles of the invention and its practical application, and to enable others of ordinary skill in the art to understand the invention for various embodiments with various modifications as are suited to the particular use contemplated.

1. A method for constructing a non-uniform wave velocity field model for an underground mine, comprising the steps of:
S1. selecting a plurality of rock materials, preparing a plurality of regular blocks from the rock materials, and measuring a reference wave velocity for each of said regular blocks;
S2. utilizing said regular blocks to prepare a plurality of rock specimens, performing a wave velocity test experiment on each of said rock specimens to obtain experimental data, and constructing a wave velocity quantification formula by fitting said experimental data;
S3. constructing a three-dimensional (3D) block model of a prediction area based on spatial features of the prediction area, selecting a unit size, dividing said 3D block model into a plurality of block unit models according to said unit size, and generating a plurality of lithological block unit models by performing spatial interpolation on said block unit models;
S4. constructing a 3D engineering geological characterization model based on a mapping relationship between Rock Quality Designation (RQD) values and fracture density, lithological data of said prediction area, in-situ stress test data of said prediction area, said spatial features of the prediction area, and said 3D block model; and
S5. extracting geological feature data from said 3D engineering geological characterization model, assigning a wave velocity to each of said plurality of lithological block unit models using said wave velocity quantification formula based on said geological feature data, and iterating through all of said lithological block unit models to obtain a 3D non-uniform wave velocity field model;
wherein said step S2 comprises the steps of:
S201. pre-fabricating different fracture densities and different fracture dip angles in said plurality of regular blocks using a Brazilian splitting method to obtain said plurality of rock specimens;
S202. placing said rock specimens in a fixture, performing the wave velocity test experiment on each of said rock specimens under a plurality of different normal stress conditions, and recording the experimental data, wherein said experimental data includes a wave velocity, a fracture density of the rock specimen, a normal stress applied to the rock specimen, and a fracture dip angle of the rock specimen, and wherein said fracture dip angle is an angle between a fracture and the normal stress; and
S203. plotting experimental data curves based on said experimental data, establishing a fitting formula, and thereby constructing said wave velocity quantification formula, wherein said wave velocity quantification formula is:
$$v = \sqrt{A \cdot {sin}^{2} α + B {cos}^{2} α} \cdot {v}_{0} \cdot {log}_{2} ( C \cdot p - D \cdot m + E ) \qquad ( 1 )$$
wherein v represents the wave velocity, v₀ represents said reference wave velocity, m represents the fracture density of the rock specimen, p represents the normal stress applied to the rock specimen, a represents the fracture dip angle of the rock specimen, A represents a sine weight coefficient for the fracture dip angle, B represents a cosine weight coefficient for the fracture dip angle, C represents a normal stress gain coefficient, D represents a fracture density attenuation coefficient, and E represents a comprehensive correction coefficient, and wherein said coefficients are constant coefficients obtained by fitting said experimental data.

2. The method according to claim 1, wherein said step S3 comprises the steps of:
S301. constructing said 3D block model based on said spatial features of the prediction area;
S302. selecting the unit size, and dividing said 3D block model into the plurality of identically sized block unit models based on said spatial features of the prediction area and said unit size; and
S303. performing spatial interpolation for each of said block unit models based on said lithological data of the prediction area to generate said plurality of lithological block unit models.

3. The method according to claim 2, wherein said spatial features of the prediction area in said step S3 comprise: geometric parameters of the prediction area, a 3D layout of voids within the prediction area, geometric parameters of the voids within the prediction area, a number of boreholes within the prediction area, a volume of the boreholes within the prediction area, and a shape of the boreholes within the prediction area;
wherein said voids within the prediction area comprise tunnels and goafs within the prediction area.

4. The method according to claim 1, wherein said step S4 comprises the steps of:
S401. extracting a 3D layout and geometric parameters of tunnels within the prediction area based on engineering structural diagrams of the prediction area, simulating said tunnels as pipes, and constructing an interconnected tunnel model;
S402. extracting a 3D layout and geometric parameters of goafs within the prediction area based on the engineering structural diagrams, simulating said goafs as cuboids of different sizes, and constructing a goaf model;
S403. merging said tunnel model and said goaf model using a Boolean union operation to obtain a void model of the prediction area, thereby obtaining void information for the prediction area;
S404. constructing an in-situ stress calculation formula through outlier screening and multiple linear regression analysis based on said in-situ stress test data of the prediction area to obtain an in-situ stress of the prediction area;
S405. collecting a plurality of rock cores from the prediction area, capturing images of said rock cores, and obtaining RQD values for said rock cores;
S406. inputting said RQD values into a preset mapping relationship between RQD values and fracture density to obtain the fracture density; and
S407. performing spatial interpolation on said lithological block unit models based on said void information, said in-situ stress, said fracture density, and said lithological data of the prediction area to construct said 3D engineering geological characterization model.

5. The method according to claim 4, wherein said step S405 comprises the steps of:
S415. collecting a plurality of rock cores from the prediction area and capturing a plurality of rock core images of the prediction area;
S425. identifying marking information in each of said rock core images using Optical Character Recognition (OCR) technology to generate a file containing a borehole number and a borehole depth, and uniformly naming said file;
S435. parsing a core length of a borehole corresponding to a rock core image based on the naming of said file;
S445. automatically cropping an effective area of a rock core using an object detection algorithm, identifying a lithology name of said effective area, and assigning a corresponding lithology code; and
S455. identifying a length of said effective area using a semantic segmentation model and calculating the RQD value of said rock core.

6. The method according to claim 5, wherein said lithological data of the prediction area comprises: said borehole number, said borehole depth, said core length of the borehole, said lithology name, said lithology code, said length of the effective area, and said RQD value.

7. The method according to claim 4, wherein said preset mapping relationship between RQD values and fracture density in said step S406 is:
$$RQD ( n ) = \{ \begin{matrix}\frac{n}{n + 1} {\int }_{0.1}^{1} f ( x ) xdx + \frac{1}{n + 1} , 0 \leq n \leq 9 \\ \frac{n}{n + 1} {\int }_{0.1}^{1} f ( x ) xdx , n > 9\end{matrix} \qquad ( 2 )$$
wherein n represents the fracture density, f(x) represents a fracture distribution function, and x represents fracture spacing; and
wherein said fracture spacing is obtained by fitting experimental data curves.

8. The method according to claim 1, wherein said step S5 comprises the steps of:
S501. presetting a lithological data-to-reference wave velocity mapping relationship based on said plurality of rock materials and said measured reference wave velocities;
S502. assigning a reference wave velocity to each of said lithological block unit models according to said preset lithological data-to-reference wave velocity mapping relationship, and iterating through all said lithological block unit models to obtain a 3D block reference wave velocity model;
S503. reading an in-situ stress, a fracture density, a fracture dip angle, and void information of the prediction area from said 3D engineering geological characterization model;
S504. calculating a normal stress based on said in-situ stress of the prediction area;
S505. constructing a wave velocity quantification formula for the non-uniform wave velocity field based on said wave velocity quantification formula, wherein said formula is:
$$V = \sqrt{A \cdot {sin}^{2} β + B {cos}^{2} β} \cdot {v}_{0} \cdot {log}_{2} ( C \cdot P - D \cdot n + E ) \qquad ( 3 )$$
wherein V represents a wave velocity of the non-uniform wave velocity field, v₀ represents said reference wave velocity, n represents said fracture density, P represents said normal stress, β represents said fracture dip angle, and A,B,C,D,E are the constant coefficients obtained by fitting said experimental data; and
S506. substituting said fracture density, said fracture dip angle, and said normal stress into the wave velocity quantification formula for the non-uniform wave velocity field to update wave velocities in said 3D block reference wave velocity model, thereby obtaining said 3D non-uniform wave velocity field model; wherein, in conjunction with said void information, a wave velocity in voids is updated to an atmospheric wave velocity.
